(19) United States
(12) Patent Application Publication
(10) Pub. No.: US 2024/0092378 A1
(43) Pub. Date: Mar. 21, 2024

(54) OPERATING SYSTEM FOR CONTROLLING A VEHICLE

(71) Applicant: Schaeffler Technologies AG & Co. KG, Herzogenaurach (DE)

(72) Inventors: Roman JOERGER, Karlsruhe (DE); Paul HAIDUK, Langen (DE); Niclas BIENEFELD, Göppingen (DE); Karsten GEUDER, Aurachtal (DE)

(73) Assignee: Schaeffler Technologies AG & Co. KG, Herzogenaurach (DE)

(21) Appl. No.: 17/767,971

(22) PCT Filed: Sep. 16, 2020
(86) PCT No.: PCT/DE2020/100803

§ 371 Date: Apr. 11, 2022

(30) Foreign Application Priority Data
Oct. 10, 2019 (DE) 102019127295.5

(51) Int. Cl. B60W 50/14

(52) U.S. Cl. CPC B60W 50/14; B60W 2050/146

(57) ABSTRACT

An operating system for controlling a vehicle, the operating system having an operating element for a manual operation by a vehicle operator; a display module in order to present the vehicle surroundings with a vehicle projection integrated therein. The operation of the operating element produces a change in the vehicle projection within the vehicle surroundings and a computer system causes the vehicle to move in the vehicle surroundings analogously to the change in the vehicle projection within the vehicle surroundings. A method for controlling the vehicle using the operating system is also provided. The vehicle is an autonomously drivable vehicle, preferably an all-wheel-steered omnidirectionally drivable vehicle, thereby allowing a reliable, secure, and simultaneously intuitive control of the vehicle.

### CROSS-REFERENCE TO RELATED APPLICATIONS

This application is the U.S. National Phase of PCT Appln. No. PCT/DE2020/100803, filed Sep. 16, 2020, which claims priority from German Patent Application No. DE 10 2019 127 295.5, filed Oct. 10, 2019, the entire disclosures of which are incorporated by reference herein.

### TECHNICAL FIELD

The disclosure relates to an operating system for controlling a vehicle, in particular for controlling an autonomously, preferably all-wheel-steered and omnidirectionally drivable vehicle.

### BACKGROUND

In particular, in the case of an autonomous, all-wheel-steered and omnidirectional vehicle, a partially autonomous driving mode or a manual control option can be provided for this vehicle in addition to a fully autonomous driving mode. Since, according to this example, all four wheels can preferably be steered individually, lateral guidance using a conventional steering wheel with only one degree of freedom is not expedient.

For example, an operating system for controlling a vehicle according to the published application DE 198 03 873 A1 is known in principle. This published application relates to an operating system for controlling at least the transverse movement of a vehicle, in particular for an all-wheel-steered vehicle, with a manually operable operating element. The control element can be actuated in rotation about an axis of rotation that is essentially parallel to the vertical axis of the vehicle for setting rotary vehicle transverse movement components and can be actuated in a translatory manner for setting translatory vehicle transverse movement components in the vehicle transverse direction. This operating system is intended in particular for controlling, i.e., steering, all-wheel-steered automobiles. In doing so, the driver has to monitor their surroundings with constant external visual checks in order to avoid accidents.

The driver needs a lot of information about the surroundings, especially for precise control of the vehicle, above all when maneuvering slowly in a confined space, for example when parking or maneuvering. 360-degree cameras are also known, with the driver having to establish a mental connection between their operating inputs and the displayed image of the 360-degree camera system when the aforementioned operating system interacts with a 360-degree camera display system.

Alternative display systems that are not integrated into the vehicle system, such as smartphones, are not recommended because the driver would have to take their hands off the control element. In addition, there would be no smooth transition from manual driving to assisted driving and vice versa, because the smartphone would first have to be set up. This thus increases the overall risk during driving and is therefore not preferable.

### SUMMARY

The object of the disclosure is to create an operating system for controlling a vehicle, in particular for controlling an autonomously, preferably all-wheel-steered and omnidirectionally drivable vehicle and a related method to enable reliable, safe and at the same time intuitive control.

The object is achieved according to the disclosure by an operating system for controlling a vehicle, in particular for controlling an autonomously, preferably all-wheel steered and omnidirectionally drivable vehicle with one or more of the features described herein and a method for controlling a vehicle, in particular for controlling an autonomously, preferably all-wheel steered and omnidirectionally drivable vehicle with one or more of the features described herein. Preferred embodiments are specified in the claims and the following description, each of which can either be used individually or in combination.

The disclosure thus relates to an operating system for controlling a vehicle, the operating system having an operating element for manual operation by a vehicle operator; a display module to present the vehicle surroundings with a vehicle projection integrated therein, wherein operating the operating element produces a change in the vehicle projection within the vehicle surroundings; a computer system to cause the vehicle to move in its surroundings analogous to the change in the vehicle projection within the vehicle surroundings.

The vehicle is, in particular, an autonomously, preferably all-wheel-steered and omnidirectionally drivable vehicle. Autonomous operation can be partially or fully autonomous.

The control element is an element that the vehicle operator can grasp haptically. It can be provided in addition to or as a substitute for a steering wheel in the vehicle. If the vehicle operator uses the operating element for controlling, in particular for steering and/or accelerating and decelerating, the driver operates it manually.

The display module presents a plan view of the surroundings of the vehicle as a miniaturized vehicle surroundings. In this case, the display module has, in particular, a display. This display simulates the vehicle surroundings. This can be data fed in from a sensor system, preferably in the form of a camera system, and/or data from a database system. It is thus possible that only sensor data, only database data or a combination thereof is used.

The vehicle surroundings are a graphic representation of the real surroundings of the vehicle and are presented on the display module.

The vehicle projection can be, but does not have to be, visualized on the display module. It is also possible, for example, that the vehicle projection does not form its own visual representation, but rather is determined by the contours of the operating element.

The computer system can perform the necessary arithmetic operations and communication steps in order to transfer or control the miniaturized movement of the vehicle projection in the vehicle surroundings to the physically real vehicle in the physically real surroundings.

It is therefore advantageous to use the control element for controlling the vehicle together with a representation of information about the surroundings on a display module. The user can thus specify the vehicle movement to the parking space, particularly during parking maneuvers, or select the target pose or the target parking space as the vehicle destination by using the operating element as a selection device. The control element can thus be used both for general driving control of the vehicle and for the precise specification of a target trajectory or target pose as the vehicle destination.

The control element functions in particular in a contact-analogous manner as an image of the vehicle in the surroundings. Actuation of the operating element, for example deflection or application of a force in at least one degree of freedom, leads to the input of a desired movement of the vehicle. Three degrees of freedom are advantageous for the complete control of the all-wheel-steered vehicle in particular.

In particular, it is provided that the area below the control element is configured as a screen using a display module and that information about the surroundings is displayed on it. The environmental information is rendered as vehicle surroundings that are a virtual representation of the real surroundings. The combination of operating element with a representation of the surroundings projected underneath allows particularly intuitive control of parking maneuvers in particular, since the operating element, which preferably has the outer contour of a vehicle, is moved into the parking space in order to perform a parking maneuver. Apart from parking maneuvers, the operating element preferably assumes the function of manual vehicle control or, in the case of partial or full automation, the specification of the driver's request, for example changing lanes and/or turning maneuvers.

The area in the vicinity of the control element, for example directly below it, is preferably used to display information about the surroundings. The operating element can be arranged, for example, over the center of the display module and can be guided in a translatory manner to a target position. In doing so, it can also assume the alignment at the target position in a contact-analogous manner.

It is preferably provided that the control element can be arranged on the display module for operation by the vehicle operator. This enables an immediate mental association of the control element with the vehicle projection in the context of the vehicle surroundings, so that the real vehicle can be controlled as safely as possible and with a reduced risk of accidents in the environment. For this purpose, the operating element can in particular have the contour of the vehicle in order to further facilitate mental assignment.

In principle, it is provided that the operating element can have the contour of the vehicle, in particular, in order to simplify a mental association between the vehicle projection in its vehicle surroundings and the vehicle in its surroundings with the lowest possible risk of an accident.

Furthermore, it is advantageous that the display module is designed to be arranged on the left, in the middle, on the right, in the front or behind in an interior of the vehicle. The display module can thus be used flexibly. The vehicle operator does not necessarily need an extensive field of vision to the outside, but can recognize their surroundings in particular using the display module. The interior can thus be designed to be comfortable and appropriate for the needs of the vehicle operator. The display module is particularly preferably arranged in a center console of the vehicle in order to enable convenient operation. Such an arrangement in a center console enables the driver not to have to lift their arms, which would be a strain and thus tiring, as is the case with the classic steering wheel, for example. This is particularly helpful for long distances, as well as for people with physical ailments or disabilities.

The display module can preferably be designed in such a way that a vehicle-projection-fixed representation or a vehicle-surroundings-fixed representation takes place, with this preferably being adjustable as desired. Since every vehicle operator has individual preferences and, moreover, individual mental strengths, the vehicle operator can choose the mode that seems most comfortable to them and which thus enables the vehicle to be controlled as safely as possible.

It can be advantageous that the operating element for manual operation is not detachably connected to the display module. This means that the operating element can be tilted or rotated, for example, but cannot be detached from the display module. This is advantageous in order to prevent the control element from falling, so that the vehicle stops due to lack of further operation and thus blocks the surrounding traffic and impedes the risk of an accident. A joystick, for example, can be understood as a non-detachable operating element as an analog orientation.

Alternatively, it is provided that the control element is detachably connected to the display module for manual operation. This has the advantage that the operating element can be placed, for example, simply on a vehicle destination, i.e., on a target position, within the vehicle surroundings displayed on the display module. The computer system can then itself calculate how the vehicle should or will reach the vehicle destination, possibly taking into account the detected traffic situation in the area. A further advantage is that the operating element can be operated and held comfortably, since vehicle operators have different arm lengths. This is beneficial for long journeys to prevent fatigue. A wireless mouse for a computer, for example, can be understood as an analogous orientation as a detachable operating element.

The computer system is preferably designed to cause the vehicle to move in its surroundings in real time or after at least one condition has been met, analogously to the change in the vehicle projection within the vehicle surroundings.

Real-time operation means that the vehicle is controlled or steered by the control element as with a classic steering wheel. In this case, a forward movement can also result in acceleration, for example, and a backward movement can also result in deceleration, for example. The control element thus supplements or replaces the steering wheel and/or gas and/or brake pedals.

A condition to be met can be that a final release from the vehicle operator is required before a driving maneuver is carried out. This increases safety, since the vehicle operator can intuitively assess whether, for example, a trajectory suggested by the computer system is sufficient.

Provision is preferably made for the at least one condition to be a confirmation by the vehicle operator and/or at least one condition to be the expiry of a defined time interval, for example two seconds. A condition to be fulfilled thus means in particular that the display module proposes one or more trajectories for parking, for example after a corresponding specification by the vehicle operator, with the vehicle operator then selecting or confirming a specific trajectory. Alternatively, by way of example, it can be that a specific time should first elapse before the driving maneuver is carried out by the vehicle. These are just examples. Other conditions to be met are also possible.

In particular, it is provided that the display module presents a fisheye projection. Such a projection is known to be mechanically generated by a fisheye lens. The fisheye (in English, fisheye or fisheye lens) is a name for a special lens that can display a complete field of view with the necessary distortion. In contrast to conventional non-fisheye lenses, which proportionally display an object plane perpendicular to the optical axis (gnomonic projection method), fisheye lenses display a hemisphere or more on the image plane, with clear but not excessive distortions. Straight lines that do not run through the center of the image may appear curved; the figure is strongly barrel-shaped. It usually depicts surface ratios or radial distances more faithfully than a normal gnomon-projecting wide-angle lens, and has a very large angle of view (usually 180 degrees in the image diagonal, preferably up to 220 degrees, particularly preferably 270 degrees up to 310 degrees). Angles of view of 180 degrees or more cannot be achieved with conventional projection methods. Despite the extraordinarily wide angle of view, the drop in brightness towards the edge of the image is easier to correct than with wide-angle lenses, because the image scale does not increase as much towards the edge of the image and the light does not have to illuminate such large areas. This principle is preferably applied to the display module. The advantage here is that the vehicle operator is already informed of approaching objects in advance, so that they can react in a timely and safety-conscious manner.

A preferred embodiment provides that the vehicle operator can enter a trajectory to be traveled from the vehicle to a vehicle destination via the control element in the display module. For example, they can use the control element to draw in the trajectory. However, other possibilities also fall under the above wording.

Alternatively or additionally, an input option can be provided such that the vehicle operator controls the operating element in such a way that they control the vehicle projection within the vehicle surroundings to a vehicle destination to be reached by the vehicle in its surroundings. This means that the vehicle operator stores the vehicle projection in a parking lot as the target position, for example. Optionally, the path can also be specified by individual intermediate poses of the vehicle projection. This is a simple, quick and intuitive way to control.

In particular, the vehicle imitates, as far as possible, a specification entered with the operating element for reaching the vehicle destination. This means that, for example, the operating element can be designed as a miniature car. The vehicle operator can move this miniature car in the sense of a vehicle projection on the display module, with the vehicle executing the driving movements in the real surroundings, i.e., imitating them. In order to compensate for accidental tearing of the operating element, the operating system can carry out appropriate safety measures, in particular using data from a detection system.

The disclosure also relates to a method for controlling a vehicle with an aforementioned operating system. The individual suitability specifications or functional characteristics apply analogously as process steps for the process.

### BRIEF DESCRIPTION OF THE DRAWINGS

In the following, the disclosure is explained by way of example with reference to the accompanying drawings using preferred exemplary embodiments, wherein the features presented below can present an aspect of the disclosure both individually and in combination. In the figures:

FIG. 1: shows a plan view of a display module of an operating system according to a preferred embodiment;

FIG. 2: shows a representation of an interior of a vehicle with an operating element lying thereon;

FIG. 3: shows a course of a parking maneuver using the operating system according to FIG. 1, wherein a vehicle-projection-fixed representation results;

FIG. 4: shows a course of a parking maneuver using the operating system according to FIG. 1, wherein a vehicle-surroundings-fixed representation results;

FIG. 5: shows a course of a parking maneuver using the operating system according to FIG. 1, wherein an undistorted representation results;

FIG. 6: shows a course of a parking maneuver using the operating system according to FIG. 1, wherein the display module presents a fisheye projection;

FIG. 7: shows a course of a parking maneuver using the operating system according to FIG. 1, with an operating element remaining on a vehicle destination during the parking maneuver; and

FIG. 8: shows a course of a parking maneuver using the operating system according to FIG. 1, with an operating element remaining in an original position during the parking maneuver.

### DETAILED DESCRIPTION

The disclosure relates to an operating system for controlling a vehicle, the operating system having an operating element 10 for manual operation by a vehicle operator; a display module 12 to present a vehicle surroundings 14 with a vehicle projection 16 embedded therein, wherein the operation of the operating element 10 causes a change in the vehicle projection 16 within the vehicle surroundings 14; a computer system to cause the vehicle to move in its surroundings analogous to the change in the vehicle projection 16 within the vehicle surroundings 14.

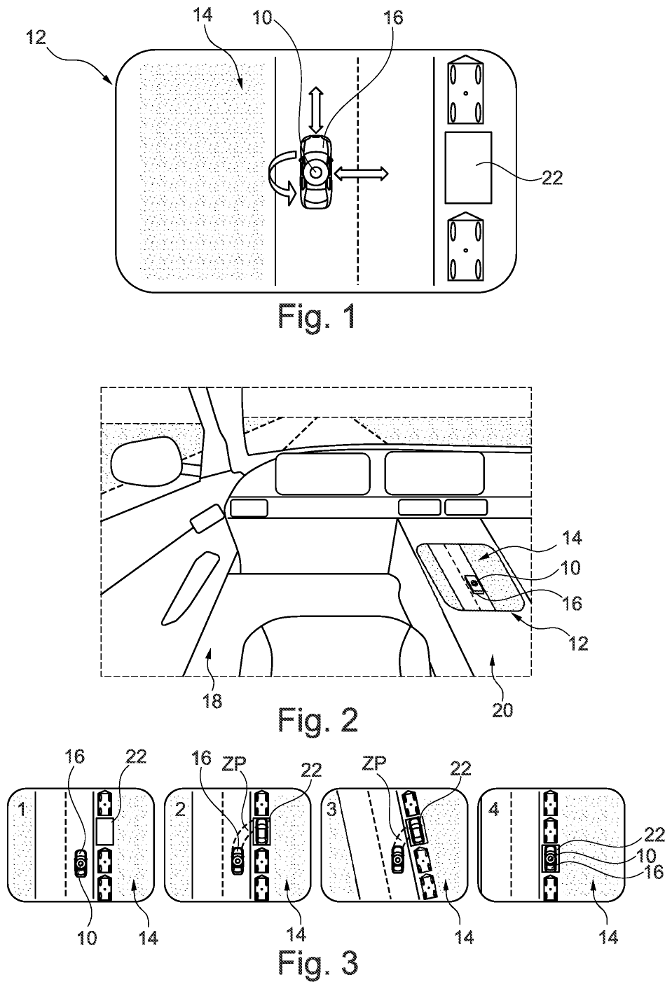

According to the disclosure, the display module 12 in the vicinity of the operating element 10, for example directly below it, is used to display the vehicle surroundings 14 as a virtual image of the real surroundings. For example, as presented in FIG. 1, operating element 10 can be arranged above a center of display module 12 that has a display and can be guided in a translatory manner to a vehicle destination 22. In this case, the operating element 10 can also assume the alignment with the vehicle destination 22 in a contact-like manner.

As presented in FIG. 1, the vehicle projection 16 is arranged on the display module 12 below the operating element 10.

The operating element 10 and the display module 12 are advantageously arranged in a center console 20 in an interior 18 of the vehicle. This arrangement is presented in FIG. 2.

However, this arrangement is not a prerequisite for using the operating system. It is also conceivable, for example, to place it in the left or right half of the vehicle, in the rear of the vehicle, or as part of a mobile vehicle control unit.

In principle, it is advantageous for the use of the disclosure to present the vehicle surroundings 14 in a vehicle-projection-fixed manner, see FIG. 3. If the vehicle moves in the area, the presented information of the vehicle area 14 is carried along. A fixed rest position is provided for the operating element 10 on the display of the display module 12. The rest position can be located in the center of the display, preferably slightly offset towards the rear of the vehicle.

Likewise, as presented in FIG. 4, it is also conceivable to use a vehicle-projection-fixed representation of the information of the vehicle surroundings 14 instead of the vehicle-surroundings-fixed representation according to FIG. 3. If the vehicle moves, this leads to a corresponding movement of the contact-analog representation of the vehicle. The previous section of the surroundings continues to be presented on the display of the display module 12. Only after a driving maneuver has been completed, for example, or after a selection has been made by the vehicle operator, is the representation of the vehicle surroundings 14 centered on a new vehicle-surroundings-fixed point.

In addition, it is preferably possible at any time to switch between the two display modes of FIGS. 3 and 4.

A representation of the vehicle surroundings 14 within the meaning of the disclosure preferably presents objects equidistantly over the entire representation space, see FIG. 5.

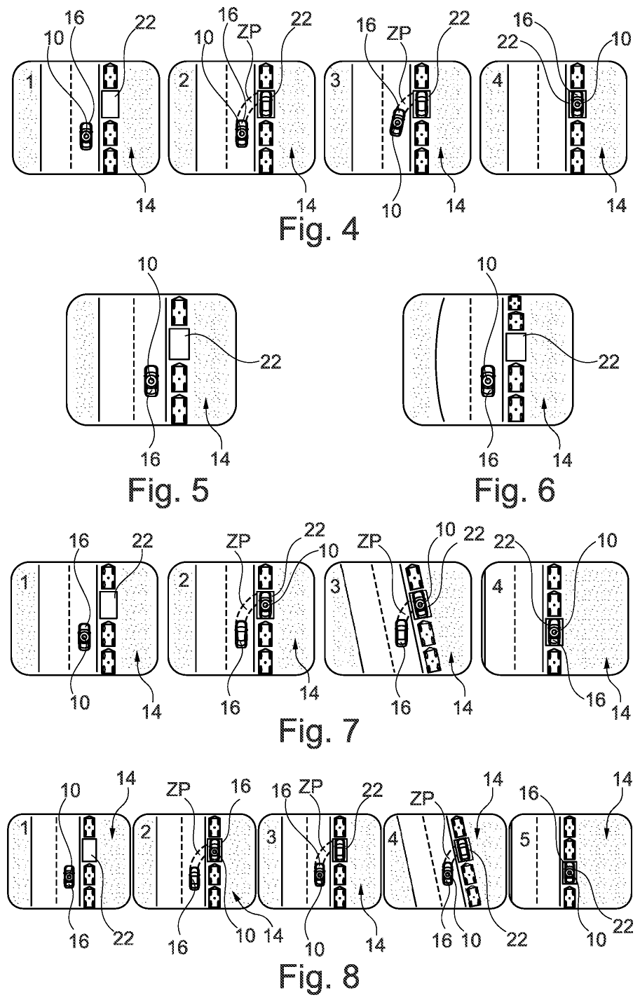

However, a representation according to FIG. 6 with a variable scale across the representation space is also possible. This type of display, which is generally known as fisheye projection, allows objects that are far away from the vehicle to be displayed, for example, by presenting them smaller as the distance increases. FIG. 5 thus shows an equidistant projection of the surroundings, and FIG. 6 shows a non-equidistant fisheye projection.

The vehicle surroundings 14 can preferably be generated based both on camera images and on database information. A combination of the two possibilities is also conceivable.

The information presented on the display module 12 is not limited to the vehicle surroundings 14. It is also possible, for example, to display navigation instructions or hazard warnings. It is also preferred to use the display of the display module 12 in combination with the operating element 10 to display any information, for example as an infotainment system.

A large number of solutions are possible for controlling the vehicle using the operating element 10. In general, a distinction can be made between real-time control, in which the vehicle operator specifies a target movement via the operating element 10, which is implemented immediately by the vehicle, and a specification of a target pose or trajectory or target trajectory by the vehicle operator, which is only implemented with a delay, in particular after a condition to be met.

For real-time control, the vehicle operator deflects the operating element 10 by only a few millimeters, for example, preferably less than and including one centimeter, particularly preferably less than and including half a centimeter. The vehicle starts moving immediately and follows the driver's instructions in real time. The representation of the vehicle surroundings 14 is moved according to the vehicle movement.

Another type of control is the specification of a vehicle destination 22 or a target trajectory of the vehicle, which is implemented by the vehicle only after the specification has been completed. A trajectory describes a chronological sequence of movements that the vehicle executes in order to be transferred from the current position to a vehicle destination 22. The vehicle operator has the option of specifying the trajectory for the vehicle directly. On the other hand, there is the possibility of specifying only one vehicle destination 22, or one vehicle destination 22 together with one or more intermediate poses ZP. In this case, the trajectory is calculated and then presented to the vehicle operator on the display of display module 12 for displaying vehicle surroundings 14.

The vehicle operator can specify a vehicle destination 22 or target trajectory by translatory and rotary displacement of the operating element 10. For this purpose, the operating element 10, which presents the vehicle in the area in a contact-like manner, is moved into a parking space as vehicle destination 22, for example. The parking space can preferably be recognized by the vehicle and presented separately.

If the vehicle operator has moved the operating part to the vehicle destination 22 and thus generated a trajectory, the vehicle follows the trajectory. This is illustrated, for example, by a virtual track on the display. In the sense of a condition to be fulfilled, one can first wait for confirmation of the trajectory by the vehicle operator, for example by a further user interface. It would also be conceivable to wait a certain time after entering the trajectory, for example two seconds, and then to follow the trajectory automatically.

During the descent of the trajectory through the vehicle, the operating element 10 can assume different positions. One possibility here would be for the operating element 10 to remain in vehicle destination 22 presented on display module 12. The original position of the vehicle in the area is marked by a virtual image of the original vehicle projection 16 in the vehicle area 14. When driving off, the operating element 10 moves back together with the vehicle surroundings 14 in the direction of the stationary virtual image. This is visualized in FIG. 7.

In contrast to the preferred embodiment according to FIG. 7, it is nevertheless preferred according to FIG. 8 that the operating element 10 returns to its initial position following specification of the trajectory by the vehicle operator, and thus marks the original position of the vehicle on the basis of the vehicle projection 16. In this case, a correspondingly placed vehicle projection 16 symbolizes the vehicle destination 22. During the descent, the operating element 10 remains in the starting position.

As shown in FIGS. 3, 4, 7 and 8, several vehicle projections 16 can be presented simultaneously on the display module 12, wherein at least one vehicle projection 16 preferably being highlighted in color, for example, which symbolizes a real-time position of the vehicle in the area. The other presented vehicle projections 16 shown can, for example, present consecutive intermediate poses ZP from the initial state to the vehicle destination 22.

It is not absolutely necessary for the vehicle projection 16 to be presented graphically. For example, the operating element 10 can also form a vehicle projection 16 with its outer contours, for example. In that case, the vehicle would not be visible on the display module 12 as a separate digital element, for example, but would be systemically determined.

### LIST OF REFERENCE SYMBOLS

10 Control element
12 Display module
14 Vehicle surroundings
16 Vehicle projection
18 Interior
20 Central region
22 Vehicle destination
ZP Intermediate pose of a vehicle projection

1. An operating system for controlling a vehicle, the operating system comprising:
an operating element for manual operation by a vehicle operator;
a display module configured to present a representation of vehicle surroundings with a vehicle projection integrated therein;
wherein operation of the operating element is adapted to produce a change in the vehicle projection within the representation of vehicle surroundings; and
a computer system configured to cause the vehicle to move in actual surroundings analogously to the change in the vehicle projection within the representation of vehicle surroundings.

2. The operating system according to claim 1, operating element is arrangeable on the display module for operation by the vehicle operator.

3. The operating system according to claim 1, wherein the display module is configured to be arranged on a left, in a middle, on a right, in a front half or in a back half in an interior of the vehicle.

4. The operating system according to claim 1, wherein the display module is configured so that a vehicle-projection-fixed representation or a vehicle-surroundings-fixed representation occurs.

5. The operating system according to claim 1, wherein the operating element is non-detachably connected to the display module for manual operation.

6. The operating system according to claim 1, wherein the operating element is detachably connected to the display module for manual operation.

7. The operating system according to claim 1, wherein the computer system is configured to cause the vehicle in real time or after at least one condition has been met to change the actual surroundings thereof analogously to the change in the vehicle projection within the representation of vehicle surroundings.

8. The operating system according to claim 1, wherein the display module presents a fisheye projection.

9. The operating system according to claim 1, wherein the system is configured such that the vehicle operator can enter a trajectory to be driven from the vehicle to a vehicle destination via the operating element in the display module.

10. A method for controlling a vehicle with the operating system according to claim 1, the method comprising:
manually operating the operating element on the display module; and
the computer system causing the vehicle in real time or after at least one condition has been met to change the actual surroundings thereof analogously to the change in the vehicle projection within the representation of vehicle surroundings on the display module.

11. The operating system according to claim 1, wherein the computer system is configured to cause the vehicle after at least one condition has been met to change the actual surroundings thereof analogously to the change in the vehicle projection within the representation of vehicle surroundings, and the at least one condition is at least one of a confirmation by the vehicle operator or an expiry of a defined time interval.

12. The operating system according to claim 1, wherein the system is configured such that the vehicle operator can enter the operating element controls such that the operating element controls the vehicle projection within the representation of vehicle surroundings to a vehicle destination to be reached by the vehicle in the actual surroundings, and the vehicle imitates a specification entered with the operating element in order to reach the vehicle destination.

13. An operating system for controlling a vehicle, the operating system comprising:
an operating element configured for manual operation by a vehicle operator;
a display module configured to present a representation of vehicle surroundings with a vehicle projection integrated therein; and
a computer system configured to cause the vehicle to move in actual surroundings of the vehicle analogously to a change in the vehicle projection made with the operating element in the representation of vehicle surroundings presented on the display module.

14. The operating system according to claim 13, wherein the operating element is arrangeable on the display module for operation by the vehicle operator.

15. The operating system according to claim 13, wherein the display module is configured so that a vehicle-projection-fixed representation is provided.

16. The operating system according to claim 13, wherein the display module is configured so that a vehicle-surroundings-fixed representation is provided.

17. The operating system according to claim 13, wherein the operating element is non-detachably connected to the display module for manual operation.

18. The operating system according to claim 13, wherein the operating element is detachably connected to the display module for manual operation.

19. The operating system according to claim 13, wherein the computer system is configured to cause the vehicle in real time or after at least one condition has been met to change the actual surroundings thereof analogously to the change in the vehicle projection within the representation of vehicle surroundings.

20. The operating system according to claim 13, wherein the computer system is configured to cause the vehicle after at least one condition has been met to change the actual surroundings thereof analogously to the change in the vehicle projection within the representation of vehicle surroundings, and the at least one condition is at least one of a confirmation by the vehicle operator or an expiry of a defined time interval.
